(19) United States
(12) Patent Application Publication
(10) Pub. No.: US 2019/0114112 A1
(43) Pub. Date: Apr. 18, 2019

(54) DATA STORAGE MANAGEMENT METHOD AND DATA STORAGE SYSTEM WITH NAMESPACE PLANNING

(71) Applicant: Silicon Motion, Inc., Jhubei City (TW)

(72) Inventor: Sheng-Liu LIN, Hsinchu City (TW)

(21) Appl. No.: 16/157,280

(22) Filed: Oct. 11, 2018

Related U.S. Application Data
(60) Provisional application No. 62/633,120, filed on Feb. 21, 2018.
(60) Provisional application No. 62/571,339, filed on Oct. 12, 2017.

(30) Foreign Application Priority Data
Sep. 28, 2018 (TW) 107134473

(51) Int. Cl. G06F 3/06; G06F 12/1009

(52) U.S. Cl. CPC G06F 3/0659; G06F 3/0604; G06F 2212/657; G06F 12/1009; G06F 2212/1044; G06F 3/0673

(57) ABSTRACT

Namespace planning of a data storage device that takes advantage of multi-channel access and considers multi-channel properties is provided. In cases with only one namespace, the host averagely assigns logical addresses of user data to the different channels to correspond to physical addresses accessed through the channels. In cases with multiple namespaces, the host averagely assigns the channels to the namespaces and thereby each namespace corresponds to the same number of channels. For each namespace, the host assigns logical addresses of user data to the assigned channels to correspond to physical addresses accessed through the assigned channels. To implement the writing of user data, the host outputs an access command that indicates the user data and physical addresses corresponding to the logical addresses of the user data.

### CROSS REFERENCE TO RELATED APPLICATIONS

This application claims the benefit of U.S. Provisional Application No. 62/571,339, filed Oct. 12, 2017, and U.S. Provisional Application No. 62/633,120, filed Feb. 21, 2018, and claims priority of Taiwan Patent Application No. 107134473, filed on Sep. 28, 2018, the entirety of which are incorporated by reference herein.

### BACKGROUND OF THE INVENTION

### Field of the Invention

The present invention relates to data storage devices and particularly relates to namespace planning of non-volatile memory.

### Description of the Related Art

There are various forms of non-volatile memory (NVM) for long-term data retention, such as flash memory, magnetoresistive RAM, ferroelectric RAM, resistive RAM, spin transfer torque-RAM (STT-RAM), and so on.

Before using a non-volatile memory in data storage, namespace planning is required first. Each command issued by a host corresponds to a namespace to be operated. For example, the host may request to read, write or erase a space of a particular namespace. How to properly plan the namespace is an important topic in the technical field.

### BRIEF SUMMARY OF THE INVENTION

In the invention, the advantages and properties of multi-channel access are taken into consideration in namespace planning of a data storage device. Accordingly, a method for data storage management and a data storage system are disclosed.

A data storage system in accordance with an exemplary embodiment of the present invention includes a host and a data storage device. The host retrieves device parameters from a data storage device. Information about the number of channels is contained in the device parameters. The host further determines the number of namespaces established in the data storage device. In cases with only one namespace, the host averagely assigns logical addresses of user data to the different channels to correspond to physical addresses accessed through the channels. To implement the writing of the user data, the host outputs an access command that indicates the user data and the physical addresses corresponding to the logical addresses of the user data.

In cases with multiple namespaces, the host averagely assigns the channels to the namespaces and thereby each namespace corresponds to the same number of channels. For each namespace, the host assigns logical addresses of user data to the assigned channels to correspond to physical addresses accessed through the assigned channels. To write user data to one namespace, the host outputs an access command that indicates the user data and the physical addresses corresponding to the logical addresses of the user data.

The host manages a logical-to-physical mapping table for each namespace, which records mapping information for the corresponding namespace to map logical addresses to physical addresses.

In another exemplary embodiment, a data storage management method is provided. According to the method, device parameters are retrieved from a data storage device, wherein device parameters include information about the number of channels. The method further determines the number of namespaces established in the data storage device. In cases with only one namespace, logical addresses of user data are assigned to the different channels based on the number of channels, to correspond to physical addresses accessed through the channels. To implement the writing of the user data, an access command is issued and the access command indicates the user data and the physical addresses corresponding to the logical addresses of the user data.

In cases with multiple namespaces, the channels are averagely assigned to the namespaces and thereby each namespace corresponds to the same number of channels. For each namespace, logical addresses of user data are related to the assigned channels to correspond to physical addresses accessed through the assigned channels. To write user data to one namespace, an access command is issued and the access command indicates the user data and the physical addresses corresponding to the logical addresses of the user data.

The method may manage a logical-to-physical mapping table to record mapping information that maps logical addresses to physical addresses.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts a data storage device 100 in accordance with an exemplary embodiment of the present invention, which operates according to commands from a host 104 with the commands indicating physical page addresses accessed through the channels CH#0 to CH#3; and

FIG. 2 is a flowchart depicting a data storage management method in accordance with an exemplary embodiment of the present invention.

### DETAILED DESCRIPTION OF THE INVENTION

The following description shows exemplary embodiments of carrying out the invention. This description is made for the purpose of illustrating the general principles of the invention and should not be taken in a limiting sense. The scope of the invention is best determined by reference to the appended claims.

A non-volatile memory for long-term data retention may be a flash memory, a magnetoresistive RAM, a ferroelectric RAM, a resistive RAM, a spin transfer torque-RAM (STT-RAM) and so on. A non-volatile memory may be used to implement a data storage device or a data center. The following discussion uses flash memory as an example.

Flash memory is often used as a storage medium in today's data storage devices. Flash memory is often implemented in memory cards, USB flash devices, SSDs, and so on. In another exemplary embodiment, a flash memory may be packaged with a controller to form a multiple-chip package named eMMC.

A data storage device using a flash memory as a storage medium can be applied in a variety of electronic devices, including a smartphone, a wearable device, a tablet computer, a virtual reality device, etc. A calculation module of an electronic device may be regarded as a host that operates a data storage device equipped on the electronic device to access a flash memory within the data storage device.

A data center may be built with flash memories as the storage medium. For example, a server may operate an array of SSDs to form a data center. The server may be regarded as a host that operates the SSDs to access the flash memories within the SSDs.

After the initialization of a data storage device, a host may output an identification (identifying) command to the data storage device and the data storage device returns device parameters, e.g. including an LBA (logical block address) format, the total number of channels, the total number of LUNs (logical unit numbers), a PU (parallel unit) size, the total number of planes, the total number of blocks, or the total number of pages. The LUNs are provided to recognize the smallest units controlled by chip enable (CE) signals. The PU size shows the number of LUNs accessed through the same channel. The smallest unit for management of user data is a logical block. In an exemplary embodiment, a logical block relates to data of 512B or 4 KB.

Based on the device parameters retrieved from the data storage device, the host performs namespace planning for the data storage device. After the namespace planning, the host can output access commands to access the data storage device. An access command may indicate a starting PPA (physical page address), the requested amount of PPAs, a memory address caching the write data, and so on. A PPA indicating a physical page may be preferably represented by a channel number, a logical unit number, a plane number, a block number, a page number, and so on. An access command may further indicate a namespace number ID of the requested namespace. According to the received access command, the data storage device reads/writes data from/to the space addressed by the indicated physical address.

The host preferably generates/manages a logical-to-physical mapping table L2P to record the mapping relationship between logical block addresses and physical page addresses. In an exemplary embodiment, each namespace has a corresponding logical-to-physical mapping table. In another exemplary embodiment, a global logical-to-physical mapping table is managed for all namespaces. The namespace planning of the present invention is based on the operational efficiency of flash memory—the advantages of multi-channel access and operational considerations of flash memory are taken into account in namespace planning.

In order to achieve the highest efficiency in the data storage device accessing, the host preferably designs the access command to access physical page addresses of the different channels. When the data storage device performs a write operation according to the received access command, the sectors of user data requested to be written to the data storage device at the physical page addresses of the different channels are written to the indicated storage space in parallel by multi-channel accessing. In an exemplary embodiment, the data storage device uses the same chip enable command to implement write operations.

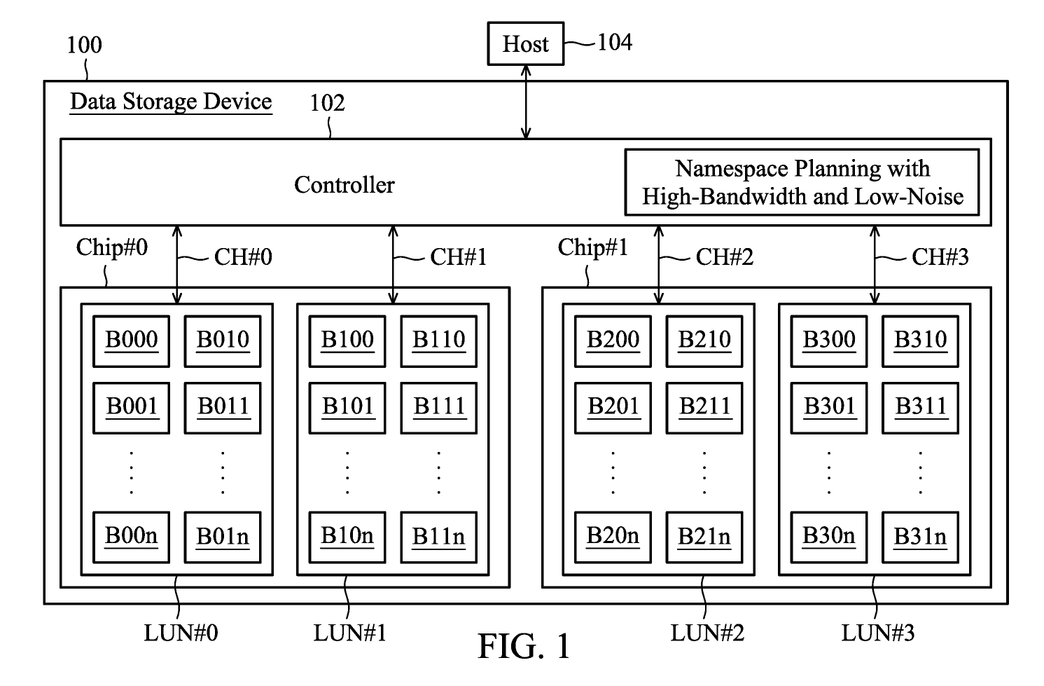

FIG. 1 depicts a data storage device 100 in accordance with an exemplary embodiment of the present invention. A host 104 requests to write user data to physical page addresses accessed through the channels CH#0 . . . CH#3. The data storage device 100 and the host 104 form a data storage system. In the exemplary embodiment of FIG. 1, two flash memory chips Chip#0 and Chip#1 are provided. The flash memory chip Chip#0 includes two separate areas differentiated by logic unit numbers #0 and #1 (LUN#0 and LUN#1). The flash memory chip Chip#1 includes two separate areas differentiated by logic unit numbers #2 and #3 (LUN#2 and LUN#3). Logic unit numbers #0 and #1 (LUN#0 and LUN#1) correspond to channels CH#0 and CH#1, and logical unit numbers #2 and #3 (LUN#2 and LUN#3) correspond to channel CH#2 and CH#3. Logic unit number #0 (LUN #0) relates to access of two planes: one plane includes blocks B000, B001 . . . B00n, and the other plane includes blocks B010, B011 . . . B01n. Logic unit number #1 (LUN #1) relates to access of two planes: one plane includes blocks B100, B101 . . . B10n, and the other plane includes blocks B110, B111 . . . B11n. Logic unit number #2 (LUN #2) relates to access of two planes: one plane includes blocks B200, B201 . . . B20n, and the other plane includes blocks B210, B211 . . . B21n. Logic unit number #3 (LUN #3) relates to access of two planes: one plane includes blocks B300, B301 . . . B30n, and the other plane includes blocks B310, B311 . . . B31n. The controller 102 may access the eight planes through the four channels CH#0 . . . CH#3. In such an architecture, the host 104 may assign eight sectors of user data to correspond to physical page addresses within the eight planes which are accessed in parallel through the different channels CH#0 . . . CH#3. The data storage device may operate the four channels CH#0 . . . CH#3 to store data. Each channel may be shared by multiple write operations in an interleaving way to further speed up write operations.

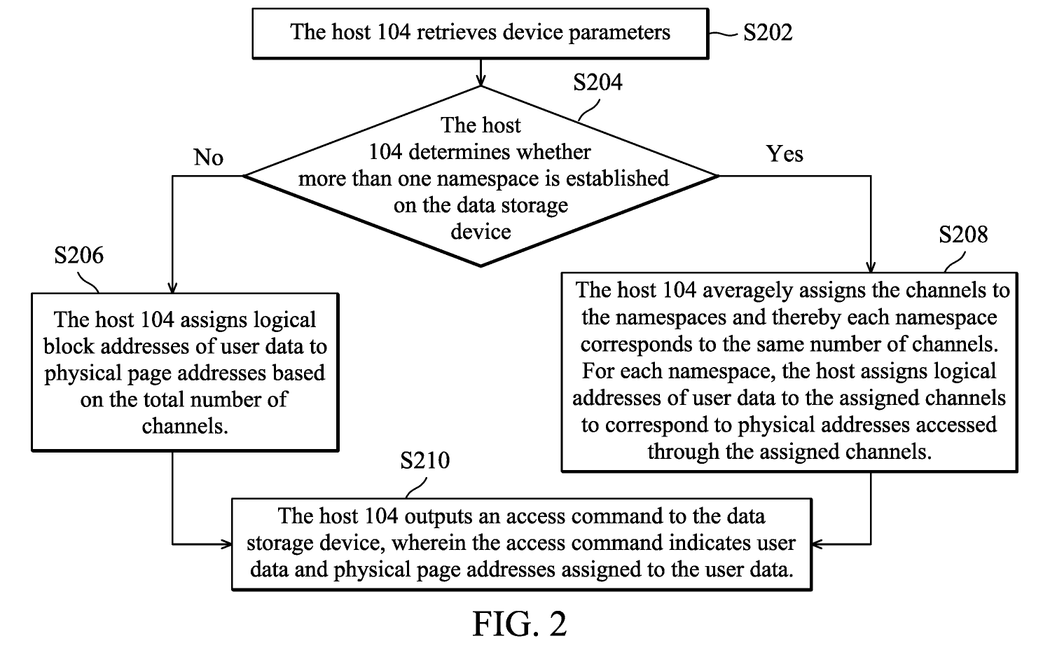

FIG. 2 is a flowchart depicting a data storage management method in accordance with an exemplary embodiment of the present invention. In step S202, the host 104 retrieves device parameters. In an exemplary embodiment, the host 104 outputs an identification command to the data storage device and the data storage device returns device parameters to the host 104.

In step S204, the host 104 determines whether more than one namespace is established on the data storage device. If not, step S206 is performed. If yes, step S208 is performed.

In step S206, the host 104 assigns logical block addresses of user data to physical page addresses based on the total number of channels. In an exemplary embodiment, all channels are evenly used by the single namespace. When the host 104 requests to establish one namespace (e.g., to establish a namespace #0), the host 104 generates a logical-to-physical mapping table #0 to record the mapping relationship between logical block addresses and physical page addresses. The host 104 maps logical block addresses of user data to physical page addresses based on the total number of channels. In an exemplary embodiment, eight sectors of user data recognized by logical block addresses LBA#0˜#7 are requested to be written to namespace #0. In the architecture of FIG. 1, the host 104 assigns the eight logical block addresses LBA#0˜#7 to the eight planes accessed in parallel through the four channels CH#0 to CH#3 to correspond to eight pages in eight blocks of the eight planes. Eight physical page addresses accessed in parallel through the four channels CH#0 to CH#3 are assigned to correspond to the eight logical block addresses LBA#0 to LBA#7. The host 104 preferably uses pointers to point to the assigned physical page addresses. In an exemplary embodiment, the eight physical page addresses assigned to correspond to LBA#0 to LBA#7 are [#0,#0,#0,#0,#0], [#0,#0,#1,#0,#0], [#1,#1,#0,#0,#0], [#1,#1,#1,#0,#0], [#2,#2,#0,#0,#0], [#2,#2,#1,#0,#0], [#3,#3,#0,#0,#0] and [#3,#3,#1,#0,#0]. The first value represents a channel number, the second value represents a logical unit number, the third value represents a plane number, the fourth value represents a block number, and the fifth value represents a page number. The physical page indicated by each physical page address stores one sector of user data. After all pages of a particular block of a particular plane have been filled with data, the host 104 then points the pointer to a preset starting page of the next block, such as page #0 of the next block.

In an exemplary embodiment, all channels are available to the host 104 to assign physical page addresses for the storage of user data. The host 104 may simulate a super block by blocks provided on the different planes (accessed through the different channels with the different LUNs). In a super block, the pages provided on the different blocks and numbered by the identical page number simulate a super page. To write only one sector of user data to the namespace #0, the host 104 may output an access command indicating eight physical page addresses to the data storage device with only one physical page address is really assigned to store valid data and the other seven physical page addresses are assigned to store dummy data. In another exemplary embodiment, the request to write dummy data is omitted.

In step S208, for the multi-namespace case, the host 104 averagely assigns the channels to the namespaces and thereby each namespace corresponds to the same number of channels. For each namespace, the host assigns logical addresses of user data to the assigned channels to correspond to physical addresses accessed through the assigned channels. In an exemplary embodiment, the host 104 requests to establish two namespaces (e.g., to establish namespaces #0 and #1), and the returned device parameters show that the total number of channels is 4. The host 104, therefore, assigns two channels to correspond to each namespace. For example, channels CH#0 and CH#1 are assigned to namespace #0, and channels CH#2 and CH#3 are assigned to namespace #1. The host 104 generates a logical-to-physical mapping table #0 for the namespace #0 and a logical-to-physical mapping table #1 for the namespace #1 to record the mapping relationship between logical block addresses and physical page addresses. In some exemplary embodiments, the host 104 may manage a global logical-to-physical mapping to record the mapping relationship of all namespaces #0 and #1 to map the logical block addresses of user data to physical page addresses.

The following discussion is based on the architecture of FIG. 1. To write four sectors of user data (with logical block addresses LBA#8 to #11) to namespace #0, the host 104 assigns the four logical block addresses LBA#8˜#11 to the two channels of namespace #0. Thus, four physical page addresses corresponding to the two channels CH#0 and CH#1 are assigned to the four logical block addresses LBA#8˜#11. In an exemplary embodiment, the four physical page addresses assigned to correspond to LBA#8 to LBA#11 are [#0,#0,#0,#0,#0], [#0,#0,#1,#0,#0], [#1,#1,#0,#0,#0] and [#1,#1,#1,#0,#0]. The first value represents a channel number, the second value represents a logical unit number, the third value represents a plane number, the fourth value represents a block number, and the fifth value represents a page number. The physical page indicated by each physical page address stores one sector of user data. To write eight sectors of user data (with logical block addresses LBA#12 to #19) to namespace #1, the host 104 assigns the eight logical block addresses LBA#12˜#19 to the two channels of namespace #1. Thus, eight physical page addresses accessed through the two channels CH#2 and CH#3 are assigned to correspond to the eight logical block addresses LBA#12˜#19. In an exemplary embodiment, the eight physical page addresses assigned to correspond to LBA#12˜#19 are [#2,#2,#0,#0,#0], [#2,#2,#1,#0,#0], [#3,#3,#0,#0,#0], [#3,#3,#1,#0,#0], [#2,#2,#0,#0,#1], [#2,#2,#1,#0,#1], [#3,#3,#0,#0,#1] and [#3,#3,#1,#0,#1]. The first value represents a channel number, the second value represents a logical unit number, the third value represents a plane number, the fourth value represents a block number, and the fifth value represents a page number.

In step S210, the host 104 outputs an access command to the data storage device, wherein the access command indicates user data and physical page addresses assigned to the user data. In an exemplary embodiment, the host 104 outputs the access command to the data storage device after the assignment of the physical page addresses, with the access command indicating user data and physical page addresses assigned to the user data. According to the received access command, the data storage device stores the user data at the physical page addresses. Data storage management is achieved.

In an exemplary embodiment, the namespace #0 stores the software of the operating system and the namespace #1 stores user data. When user data is requested by the operating system, centralization of access on some specific channels is avoided. The operating system and the user data access are operated at high speed and do not interfere with each other. In another exemplary embodiment, the namespace #0 stores confidential data and the namespace #1 stores non-confidential data. The separated access channels allow the host 104 to efficiently manage data according to user privilege.

According to the aforementioned techniques, the host 104 evenly assigns all the channels to the different namespaces, and then determines the physical page addresses based on the assignment of channels. In this manner, data access in each namespace is limited to the assigned channels. The different namespaces will not interfere with each other when being accessed. The noise caused by data-access interference is eliminated, achieving the object of the present invention.

Namespace planning based on the aforementioned technical content is considered within the scope of the present invention. Based on the aforementioned technical content, the present invention further relates to a non-volatile memory operation method.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage management method, comprising:
retrieving device parameters from a data storage device, wherein the device parameters include information about the number of channels;
determining the number of namespaces established in the data storage device;
when only one namespace is established, assigning, based on the number of channels, logical addresses of user data to the channels to correspond to physical addresses accessed through the channels; and
outputting an access command to the data storage device to implement the writing of the user data, wherein the access command indicates the user data and the physical addresses corresponding to the logical addresses of the user data.

2. The data storage management method as claimed in claim 1, further comprising:
when multiple namespaces are established, assigning the channels to the namespaces and thereby each namespace corresponds to the same number of channels, wherein, for each namespace, logical addresses of user data are assigned to the assigned channels to correspond to physical addresses accessed through the assigned channels.

3. The data storage management method as claimed in claim 1, further comprising:
managing a logical-to-physical mapping table to record mapping information that maps the logical addresses of the user data to the physical addresses corresponding to the logical addresses of the user data.

4. The data storage management method as claimed in claim 2, further comprising:
separately managing logical-to-physical mapping tables for the different namespaces to record mapping information that maps logical addresses of user data to physical addresses corresponding to the logical addresses of the user data.

5. A data storage system, comprising:
a data storage device; and
a host, retrieving device parameters from the data storage device which include information about the number of channels, and determining the number of namespaces established in the data storage device,
wherein:
when only one namespace is established, the host averagely assigns logical addresses of user data to the channels to correspond to physical addresses accessed through the channels;
the host outputs an access command to the data storage device to implement the writing of the user data; and
the access command indicates the user data and the physical addresses corresponding to the logical addresses of the user data.

6. The data storage system as claimed in claim 5, wherein:
when multiple namespaces are established, the host averagely assigns the channels to the namespaces and thereby each namespace corresponds to the same number of channels; and
for each namespace, the host assigns logical addresses of user data to the assigned channels to correspond to physical addresses accessed through the assigned channels.

7. The data storage system as claimed in claim 6, wherein:
the host separately manages logical-to-physical mapping tables for the different namespaces to record mapping information that maps logical addresses of user data to physical addresses corresponding to the logical addresses of the user data.
